(19) United States
(12) Patent Application Publication
(10) Pub. No.: US 2010/0294888 A1
(43) Pub. Date: Nov. 25, 2010

(54) AIRCRAFT OPENING PANEL, ESPECIALLY AN AIRPLANE CABIN DOOR

(75) Inventors: Roland Texcier, Montrabe (FR); Christophe Perrier, Toulouse (FR); Renaud Othomene, Toulouse (FR)

Correspondence Address: YOUNG & THOMPSON, 209 Madison Street, Suite 500, Alexandria, VA, 22314, US

(73) Assignee: LATECOERE, Toulouse (FR)

(21) Appl. No.: 12/864,086

(22) PCT Filed: Mar. 12, 2009
(86) PCT No.: PCT/IB09/00504

§ 371 Date: Jul. 22, 2010

(30) Foreign Application Priority Data
Mar. 14, 2008 (FR) 08/01386

(51) Int. Cl. B64C 1/14

(52) U.S. Cl. 244/129.5

(57) ABSTRACT

A panel (1) includes a plurality of retainers (7) along its lateral sides, these being intended to engage, in the closure position of the panel, with corresponding retainers located on the frame structure of this panel. The panel includes at least one beam (3), a longitudinal end portion of which has a slot (15) emerging in the end face of the beam and located at a suitable position for mounting a retainer (6) directly on this beam. The retainer includes a retaining part (7) and a mounting part (8) formed by a base, the mounting part forming one body with the retaining part. The mounting part and the slot (15) are shaped such that the mounting part engages tightly in the slot and the mounting part is fastened to the beam by fastening members, particularly nuts and bolts, which are positioned approximately perpendicular to the principal direction of the beam.

The present invention relates to an aircraft opening panel, especially an airplane cabin door.

An airplane cabin door comprises, along its lateral sides, retainers, commonly called “stops”, which are intended to engage, in the closure position of the door, with corresponding retainers or stops located on the frame structure of this door. The reciprocal engagement of these respective stops upon closing the door ensures that the door is held in place so as to be able to withstand the stresses said door experiences during the flight of the airplane, especially those exerted by the cabin pressurization. Specifically, the forces due to the pressurization are transferred via the stops of the door to the frame structure of this door.

Existing doors are generally produced by assembling aluminum parts, and said stops are fastened to them by means of fasteners, especially by bolts.

These fasteners must be designed to keep the stops in position and to withstand the large forces due to the pressurization.

In addition, fitting the stops involves carrying out specific machining operations at suitable points on the longerons and/or on the cross beams that the doors comprise, and also involves fastening counter-plates or other reinforcing or force-distributing parts.

These doors have the drawback of being relatively difficult to produce, owing to the large number of operations involved in fitting said stops.

In addition, the stops normally used have a tendency to warp under the effect of the pressurization.

Moreover, the trend in materials technology is to produce panels made of composite material, so as to lighten these panels and make them easier to produce.

The aim of the present invention is to remedy the drawbacks of the existing opening panels.

The main objective of the invention is therefore to provide an aircraft opening panel, especially an airplane cabin door, of easier manufacture as regards the fitting of said stops.

The aim of the invention is also to provide a solution for fastening the stops to the door that enable the forces due to pressurization to be withstood, while limiting the risks of rupture or warping.

Another objective of the invention is to provide such a panel, which can be produced entirely or partly of composite material.

The panel in question comprises, in a manner known per se, a plurality of retainers along its lateral sides, these being intended to engage, in the closure position of the panel, with corresponding retainers located on the frame structure of this panel.

According to the invention:
the panel comprises at least one beam, a longitudinal end portion of which has a slot emerging in the end face of the beam and located at a suitable position for mounting a retainer directly on this beam;
said retainer comprises a retaining part and a mounting part formed by a base, said mounting part forming one body with said retaining part;
said mounting part and said slot being shaped in such a way that the mounting part engages tightly in said slot and that said mounting part is fastened to the beam by means of fasteners, particularly nuts and bolts, which are positioned approximately perpendicular to the principal direction of the beam.

The invention thus consists in producing a beam having at least one end portion which is shaped so as to accommodate directly a mounting part integral with a retainer, with tight engagement of this end portion with this mounting part, said end portion being placed on the panel at a suitable point for it to be mounted directly.

The panel according to the invention thus makes it possible for said retainer to be mounted directly on said end portion of the beam, and therefore in a relatively simple and easily implementable manner. Consequently, it is possible to dispense with the numerous operations needed, according to the prior art, to mount a retainer or stop on an airplane cabin door structure or similar panel.

In addition, the presence of said slot in the beam, into which said mounting part of the retainer is inserted, enables the forces undergone by the stop to be transferred directly into the core of the beam.

Moreover, the fasteners are perpendicular to the axis of the beam and not parallel, as is usually the case described in the prior art. The fasteners therefore do not work in tension but in shear and the stops no longer have a tendency to warp, unlike in the case of stops fastened to the beam along a direction parallel to the axis of the latter.

Preferably, the panel comprises at least one beam, the two longitudinal end portions of which each have a slot emerging in the end face of the corresponding longitudinal end portion, said slots being located at the respective places suitable for mounting two retainers directly on these end portions, on two opposed sides of the panel.

Thus, any one beam comprises two retainers, along two opposed sides of the panel.

Advantageously, said beam extends in a single piece between said opposed sides of the panel.

Furthermore, advantageously and according to the invention, the panel comprises at least one longeron.

Advantageously, the panel comprises several beams, the number of which enables all of the retainers that the panel comprises to be mounted.

Preferably, said beam has a greater width and/or a greater thickness, and/or has walls of greater thickness, in said end portion intended to accommodate a retainer, so as to have greater strength.

In particular, the beam may have, between a central portion of this beam and said end portion, an intermediate portion in which the width and/or the thickness of the beam progressively increase/increases and/or in which the thickness of the walls of the beam is increased relative to the thickness of the walls of this beam in said central portion.

This shaping makes it possible for the forces that said end portion may experience to be widely distributed.

According to a preferred embodiment of the invention, the beam progressively widens in said intermediate portion in such a way that it thus has a shape flared toward its end portion.

Advantageously, the beam is made of a molded material, especially of composite material comprising plies of fibers embedded in a resin.

Thus, the beam can be easily produced.

Preferably, in this case, the beam comprises, in said intermediate portion, stitching joining the fiber plies to one another.

These stitches reinforce the joining of the plies together and therefore increase the strength of the beam in said intermediate portion.

Moreover, the number of plies may be increased in said end portion, for the same purpose of increasing the strength of the beam at this point.

Advantageously, at least one longeron is made in several portions, said portions of said longeron being formed from plies stitched to the plies intended to form the beams, and are molded with these beams, in such a way that they are perfectly integral with the latter.

According to a preferred embodiment of the invention the beam comprises:
two longitudinal section members having a C-shaped cross section, intermediate portions of which are slightly angled on that side of the section member along which the upper and lower branches of the “C” formed by the cross section of this section member extend, these section members being placed back-to-back in such a way that they give the beam an I-shaped cross section and that their intermediate portions and their end portions define elongate spaces between them; and
inserts, which are placed between these section members, in said elongate spaces.

The invention will be clearly understood, and other features and advantages thereof will become apparent, with reference to the appended schematic drawing, which shows, by way of nonlimiting example, a preferred embodiment of the aircraft opening panel to which it relates, in which:

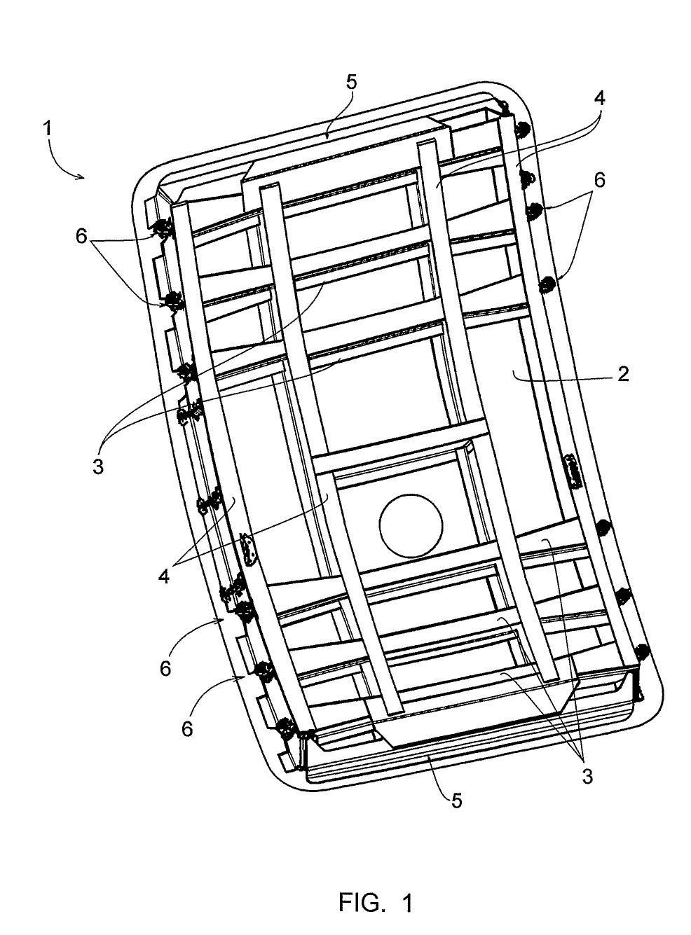

FIG. 1 is a perspective view, this panel being an airplane cabin door;

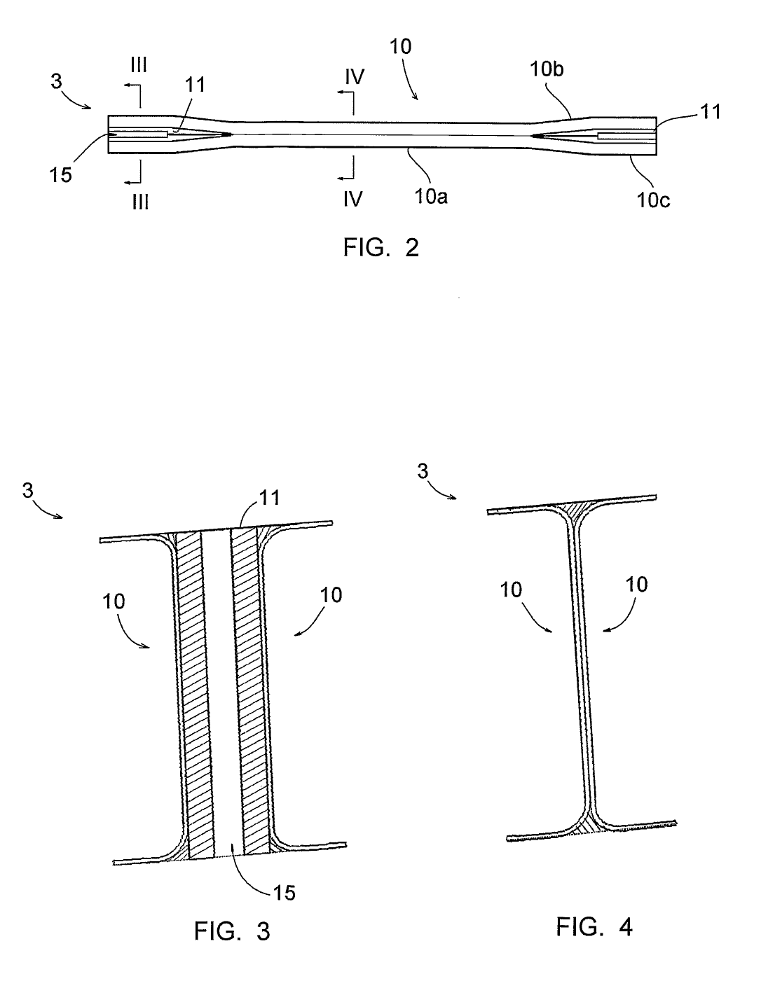

FIG. 2 is a top view of a transverse beam of the structure of this door;

FIGS. 3 and 4 are cross-sectional views of the beam along the lines III-III and IV-IV of FIG. 2, respectively; and

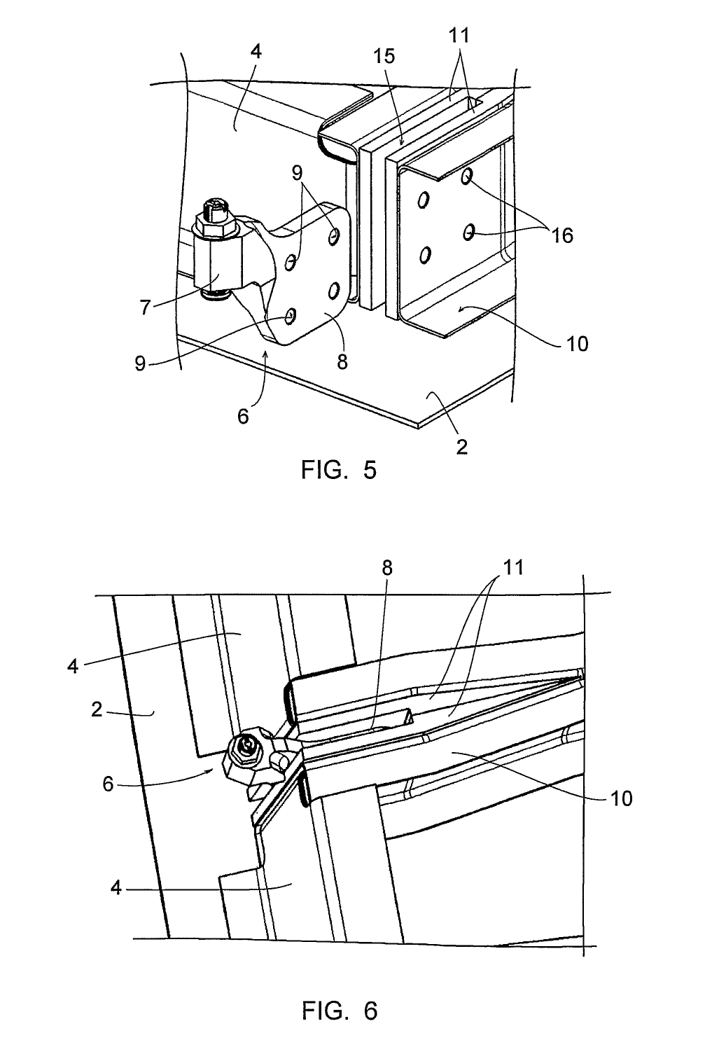

FIGS. 5 and 6 are detailed views, on a larger scale, of parts of the door, respectively before and after a retainer of this door has been mounted.

FIG. 1 shows an airplane cabin door 1 comprising a panel 2, transverse beams 3 and longerons 4 forming a structure for reinforcing the panel 2, and upper and lower transverse closure flanges 5 placed at the ends of the longerons 4. The door 1 also includes seals and seal supports (not shown) known per se.

The door 1 also includes retainers 6, commonly called “stops”, which are intended to engage, in the closed position of the door 1, with corresponding retainers or stops located on the frame structure (not shown) of this door. One of the retainers 6 is more particularly visible in FIGS. 5 and 6. Each retainer 6 comprises a retaining part 7, known per se and therefore not specifically described, and a base 8 drilled with four holes 9, which forms one body with the retaining part 7. The retainer 6, and likewise the bolts intended to be engaged in the holes 9, as will be described later, may particularly be made of titanium.

FIGS. 2 to 4, and also FIGS. 5 and 6, show more particularly a transverse beam 3. As is apparent, the beam 3 comprises two longitudinal section members 10 of C-shaped cross section and inserts 11 fitted between these section members 10, in end and intermediate portions thereof.

Each section member 10 comprises a central portion 10a, two intermediate portions 10b and two end portions 10c. The intermediate portions 10b are slightly angled on that side of the section member 10 along which the upper and lower branches of the “C” formed by the cross section of the section member extend, and the end portions 10c are slightly angled relative to the intermediate portions 10b so as to be approximately parallel to the central portion 10a.

To form the beam 3, the two section members 10 are placed back-to-back (i.e. in such a way that the upper and lower branches of these section members project in opposite directions), with the central branches of the section members coming into the immediate proximity of each other in the central portions 10a. Thus, these section members 10 give the beam 3 an I-shaped cross section, and the intermediate portions 10b and end portions 10c form flared portions of the beam 3 and define between them elongate spaces into which the inserts 11 are placed.

Each insert 11 has on the outside a shape such that it entirely fills one of these elongate spaces and includes a stop 15 emerging in the end face of the beam 3, this stop 15 being designed for tightly holding the base 8 of a retainer 6.

The beam 3 is also drilled with four holes 16, which are approximately perpendicular to the principal direction of the beam, in this slot 15, these holes 16 being arranged in such a way that the holes 9 in the base 8 are coincident with them in the mounting position of the base 8 in the slot 15. These various transverse holes 9, 16 receive the aforementioned assembly bolts.

The section members 10 and the inserts 11 may especially be made of composite material. The inserts 11 may comprise a plurality of resin-impregnated fiber plies molded so as to form the slot 15 by molding. The various plies of these inserts 11 may be stitched together by transverse reinforcing threads 17, especially Kevlar® or carbon threads.

It should be noted that, thanks to the retainers 6 being mounted on the end of the beams 3, the entire door 1, with the exception of these retainers 6, can be made of composite materials, by stitching the various fiber plies together, placing these plies in a mold and applying a curable resin, for example using an RTM (resin transfer molding) process.

FIGS. 1, 5 and 6 show that the beams 3 extend as a single piece over the entire width of the door 1 and that their slots 15 emerge on the outside of the outer longerons 4, being located slightly set back from the edges of the panel 2. Thus, the slots 15 are located at suitable positions for mounting the retainers 6 directly on the beams 3.

The longerons 4 are therefore interrupted at each transverse beam 3, and are therefore in several portions. When the entire structure of the door 1 is made of composite material, as indicated above, these portions of longerons 4 are formed from plies, optionally stitched to the plies intended to form the beams 3, and are molded with these beams 3 so that they are perfectly integral therewith.

As is apparent from the foregoing, the invention thus provides an aircraft opening panel, especially an airplane cabin door, affording the key advantages of easier manufacture as regards the fitting of the stops 6 and the ability to be completely or partly made of composite material.

The invention has been described above with reference to a preferred embodiment given by way of example. It goes without saying that the invention is not limited to this embodiment, rather it extends to all the other embodiments covered by the claims appended herewith.

1. An aircraft opening panel, especially an airplane cabin door (1), comprising a plurality of retainers (6) along its lateral sides, these being intended to engage, in the closure position of the panel, with corresponding retainers located on the frame structure of this panel, characterized in that:
the panel comprises at least one beam (3), a longitudinal end portion of which has a slot (15) emerging in the end face of the beam (3) and located at a suitable position for mounting a retainer (6) directly on this beam (3);
said retainer (6) comprises a retaining part (7) and a mounting part (8) formed by a base, said mounting part forming one body with said retaining part (7);
said mounting part (8) and said slot (15) being shaped in such a way that the mounting part (8) engages tightly in said slot (15) and that said mounting part is fastened to the beam (3) by means of fasteners, particularly nuts and bolts, which are positioned approximately perpendicular to the principal direction of the beam (3).

2. The panel as claimed in claim 1, characterized in that it comprises at least one beam (3), the two longitudinal end portions of which each have a slot (15) emerging in the end face of the corresponding longitudinal end portion, said slots being located at the respective places suitable for mounting two retainers (6) directly on these end portions, on two opposed sides of the panel.

3. The panel as claimed in claim 1, characterized in that said beam (3) extends in a single piece between said opposed sides of the panel.

4. The panel as claimed in claim 1, characterized in that it comprises at least one longeron (4).

5. The panel as claimed in claim 1, characterized in that it comprises several beams (3), the number of which enables all of the retainers (6) that the panel comprises to be mounted.

6. The panel as claimed in claim 1, characterized in that said beam (3) has a greater width and/or a greater thickness, and/or has walls of greater thickness, in said end portion intended to accommodate a retainer (6), so as to have greater strength.

7. The panel as claimed in claim 6, characterized in that the beam (3) has, between a central portion of this beam (3) and said end portion, an intermediate portion in which the width and/or the thickness of the beam (3) progressively increase/increases and/or in which the thickness of the walls of the beam (3) is increased relative to the thickness of the walls of this beam (3) in said central portion.

8. The panel as claimed in claim 7, characterized in that the beam (3) progressively widens in said intermediate portion in such a way that it thus has a shape flared toward its end portion.

9. The panel as claimed in claim 1, characterized in that the beam (3) is made of a molded material, especially of composite material comprising plies of fibers embedded in a resin.

10. The panel as claimed in claim 9, characterized in that the beam (3) comprises, in said intermediate portion, stitching joining the fiber plies to one another.

11. The panel as claimed in claim 9, characterized in that the number of plies is increased in said end portion.

12. The panel as claimed in claim 9, characterized in that at least one longeron (4) is made in several portions, said portions of said longeron (4) being formed from plies stitched to the plies intended to form the beams (3), and are molded with these beams (3), in such a way that they are perfectly integral with the latter.

13. The panel as claimed in claim 1, characterized in that the beam (3) comprises:
two longitudinal section members (10) having a C-shaped cross section, intermediate portions (10b) of which are slightly angled on that side of the section member (10) along which the upper and lower branches of the “C” formed by the cross section of this section member extend, these section members (10) being placed back-to-back in such a way that they give the beam (3) an I-shaped cross section and that their intermediate portions (10b) and their end portions (10c) define elongate spaces between them; and
inserts (11), which are placed between these section members (10), in said elongate spaces.

14. The panel as claimed in claim 2, characterized in that said beam (3) extends in a single piece between said opposed sides of the panel.

15. The panel as claimed in claim 1, characterized in that the beam (3) has, between a central portion of this beam (3) and said end portion, an intermediate portion in which the width and/or the thickness of the beam (3) progressively increase/increases and/or in which the thickness of the walls of the beam (3) is increased relative to the thickness of the walls of this beam (3) in said central portion.

16. The panel as claimed in claim 10, characterized in that the number of plies is increased in said end portion.
